(19) United States
(12) Patent Application Publication
(10) Pub. No.: US 2006/0169216 A1
(43) Pub. Date: Aug. 3, 2006

(54) Isolation, culture, and use of marine copepods in aquaculture

(76) Inventors: Robert John Shields, Waimanalo, HI (US); Anthony C. Ostrowski, Waimanalo, HI (US)

Correspondence Address: LUMEN INTELLECTUAL PROPERTY SERVICES, INC., 2345 YALE STREET, 2ND FLOOR, PALO ALTO, CA, 94306, US

(21) Appl. No.: 10/678,948

(22) Filed: Oct. 3, 2003

Related U.S. Application Data
(60) Provisional application No. 60/416,535, filed on Oct. 8, 2002.

(51) Int. Cl. A01K 61/00

(52) U.S. Cl. 119/217; 119/215

(57) ABSTRACT

Larviculture is performed using Parvocalanus sp as a feed for fish larvae. A system is described using tanks for growing Parvocalanus sp nauplii with a microalgae feed and transferring the grown Parvocalanus sp nauplii to tanks containing the fish larvae, where the functions of the tanks is interchanged. The Parvocalanus sp feed provide for higher numbers of larger juvenile fish and the rearing of larvae heretofore not reared in culture.

This application claims priority to provisional application Ser. No. 60/416,535 filed on Oct. 8, 2002, entitled ‘THE ISOLATION, CULTURE, AND USE OF MARINE COPEPODS IN AQUACULTURE,” the entire contents of which is incorporated herein by reference.

This invention was made in part with government support under Grant No. NA16FY2812 awarded by the U.S. Department of Commerce, National Oceanic and Atmospheric Administration, National Marine Fisheries Service. The government has certain rights in this invention.

### BACKGROUND OF THE INVENTION

1. Field of the Invention

The invention relates to marine larviculture.

2. Background Information

The use of cultured calanoid copepods has enabled recent breakthroughs in the larviculture of tropical lutjanid snappers and groupers (Ogle et al., 2000, Toledo et al., 1999, Schipp et al., 2001) and the nutritional superiority of marine copepods versus conventional live prey (rotifers, Artemia) has been confirmed (Shields et al., 1999). Acartia sp. copepods have been found to be effective diets for larvae of European turbot (Støttrup et al., 1986, Urup 1994) and golden snapper (Schipp et al., 2001) while extensively cultured copepods (mixed calanoid species) have been successfully used to rear red snapper and red-spotted grouper (Ogle et al., 2000, Toledo, et al., 1999, Doi et al., 1997).

Having identified the high dietary value of marine calanoid copepods, researchers and aquaculturists have been seeking to develop methods of mass culture. Until recently “extensive” rather than “intensive” copepod production techniques have predominated in this field (Liao et al., 2001, Van der Meeren and Naas 1997). In the extensive or “mesocosm” technique, a mixed assemblage of wild plankton is enclosed in a large fertilized outdoor tank, pond or lagoon (Van der Meeren and Naas, 1997, Divanach and Kentouri 2000, Benetti 2001). Fish larvae are then added to the mesocosm and allowed to graze on the endogenous plankton population. Alternatively, appropriate-sized zooplankton may be harvested from the mesocosm and supplied to larvae in separate hatchery tanks (Van der Meeren and Naas, 1997, Shields 2001). “Conventional” prey (rotifers, Artemia) may also be added during the rearing process as the endogenous plankton population becomes exhausted.

The extensive culture approach has the advantage of requiring only simple rearing facilities and of offering species and size diversity to meet the fish larvae's changing developmental needs. It is therefore especially useful in locations lacking technical resources or for new fish species for which exact dietary requirements are unknown (Dhert et al., 1997). However, productivity using this method tends to be highly variable due to lack of control over plankton abundance/species composition or physical environmental conditions. The open nature of the rearing system also offers a pathway for introduction of fish pathogens, for example, viral nervous necrosis (Liao, et al, 2001). Some operators have therefore adopted a more sophisticated extensive rearing approach in which the mesocosm is inoculated with microalgae and zooplankton from indoor stock cultures rather than from wild sources. This method has been successfully used for large-scale culture of Acartia spp, as feed for European turbot larvae and golden snapper (Urup, 1994, Schipp et al., 2001).

Indoor intensive culture systems offer an alternative means of producing large quantities of marine calanoid copepods as larval feed. Intensive culture systems utilize less water volume than extensive mesocosms and can operate independently of outdoor environmental conditions, although they require close control over dietary inputs and water quality (Støttrup et al 2000, McKinnon et al 2003). Støttrup et al, (1986) successfully reared Acartia tonsa for multiple generations in experimental rearing tanks (250-400 L volume) using the microalga Rhodomonas baltica. However adult A. tonsa densities in this system were limited to 50-100/L. Based on these and similar findings, it was initially questioned whether calanoid copepod species can attain sufficient population densities to allow economically viable intensive culture. This assumption has since been revised following the discovery that much higher culture densities (up to 5,000/L) and nauplius yields can be obtained for Acartia sp, Gladioferens imparipes and Oithona sp (Schipp, et al., 1999, Payne and Rippingale 2001, Lipman et al., 2001), Bestiolina similes, Parvocalanus crassirostris, and Acartia sinjiensis (McKinnon et al., 2003).

There still remains a significant need for improvements in isolation, culture and use of copepods in aquaculture.

Relevant Literature

McKinnon, A. D., S. Duggan, P. D. Nichols, M. A. Rimmer, G. Semmens, and B. Robino, 2003. The potential of tropical paracalanid copepods as live feeds in aquaculture. Aquaculture 223, pp. 89-106. Benetti, D. D., 2001. Mesocosm systems for semi-intensive larval rearing of marine fish. The Advocate, Feb. 2001, 17-18. Dhert, P, Divanach, P, Kentouri, M and Sorgeloos, P, 1997. Development of rearing techniques using large enclosed ecosystems in the mass production of marine fish fry. Reviews in Fisheries Science 5, 367-390. Divanach, P. and Kentouri, M., 2000. Hatchery techniques for species diversification in Mediterranean finfish larviculture. Cahiers Options Mediterraneenes 47, 75-88. Doi, M., Toledo, J. D., Golez, M. S. N. Ohno, A., 1997. Preliminary investigation of feeding performance of larvae of early red-spotted grouper, Epinephelus coiodes, reared with mixed zooplankton. In, A. Hagiwara, T. W. Snell, E. Lubzens and C. S. Tamaru, Eds: Live Food in Aquaculture, Proceedings of the live food and marine larviculture symposium, Japan, Sep. 1-4, 1996. Developments in Hydrobiology 124, 259-263. Heath, P. L. and Moore, C. G., 1997. Rearing Dover sole larvae on Tisbe and Artemia diets. Aquaculture International 5, 29-39. Liao, I., Su, H. M. and Chang, E. Y., 2001. Techniques in finfish larviculture in Taiwan. Aquaculture 200, 1-31. Lipman, E. E., Kao, K. R. and Phelps, R. P., 2001. Production of the copepod Oithona sp. under hatchery conditions. Aquaculture 2001. Abstracts of contributions presented at Aquaculture 2001 including Annual meeting of the National Shellfish Association, Annual Meeting of the Fish Culture Section of AFS, World Aquaculture 2001-The Annual International Meeting of WAS, p 379. Marshall, A. J. and Purser, G. J., 1999. The use of temperate harpacticoid copepod nauplii as a first feed for flounder larvae (Rhombosolea tapirina). World Aquaculture '99. Abstracts of contributions presented at the annual international conference of the World Aquaculture Society, p 493. Ogle, J., Lotz, J., Nicholson, C. and Barnes, D., 2000. Larval culture of red snapper Lutjanus campechanus using copepod nauplii for first feeding. Aquaculture America 2000, Abstracts of contributions presented at the annual conference of the NAA, USASA and US Chapter of the WAS, p 249. Payne, M. F. and Rippingale, R. J., 2001. Intensive cultivation of the calanoid copepod Gladioferens imparipes. Aquaculture 201, 329-342. Schipp, G. R., J. M. P. Bosmans, and A. J. Marshall, 1999. A method for hatchery culture of tropical calanoid copepods, Acartia spp. Aquaculture 174: 81-88. Schipp, G. R., J. M. P. Bosmans and D. J. Gore, 2001. A semi-intensive larval rearing system for tropical marine fish. In, C. I. Hendry, G. van Stappen, M. Wille and P. Sorgeloos (Editors), European Aquaculture Society Special Publication No. 30: Larvi 2001, 3^{rd} Fish and Shellfish Larviculture Symposium, Ghent, Belgium, pp 536-539. Shields, R. J., Bell, J. G., Luizi, F. Gara, B., Sargent, J. R. and Bromage, N. R., 1999. Natural copepods are superior to enriched Artemia nauplii as feed for halibut larvae (Hippoglossus hippoglossus) in terms of survival, pigmentation and retinal morphology: relation to dietary essential fatty acids. Journal of Nutrition 129, 1186-1194. Shields, R. J., 2001. Larviculture of marine finfish in Europe. Aquaculture 200, 55-88. Støttrup, J. G., Richardson, K., Kirkegaard, E. and Pihl, N. J., 1986. The cultivation of Acartia tonsa Dana for use as a live food source for marine fish larvae. Aquaculture 52, 87-96. Støttrup, J. G. and Norsker, N. H., 1997. Production and use of copepods in marine fish larviculture. Aquaculture 155, 231-247. Støttrup, J., 2000. The elusive copepods: their production and suitability in marine aquaculture. Aquaculture Research 31, 703-711. Toledo, J. D., M. Golez, M. Doi, and A. Ohno, 1999. Use of copepod nauplii during early feeding stage of grouper Epinephelus coioides. Fisheries science 65: 390-397. Urup, B., 1994. Methods for the production of turbot fry using copepods as food. In, P. Lavens and R. A. M. Remmerswaal, Turbot culture: problems and prospects. Proceedings of the satellite workshop of World Aquaculture '93, 25-27 May 1993, Torremolinos, Spain. European Aquaculture Society Special Publication No. 22, 47-53. Van der Meeren T. and Naas, K., 1997. Development of rearing techniques using large enclosed ecosystems in the mass production of marine fish fry. Reviews in Fisheries Science 5, 367-390.

### SUMMARY OF THE INVENTION

Novel intensive controlled larviculture methods are employed using copepod live feed that provides for enhanced survival and growth of a variety of fish larvae. The larvae are reared on a controlled feed composition of Parvocalanus sp., grown separately and then added to the larvae or in situ with microalgae in a controlled environment under conditions to provide rapid growth and improved survival during the early stages of development. The calanoid copepods for marine fish aquaculture are cultured in controlled quantities, under biosecure conditions, and to a defined nutrient composition.

### BRIEF DESCRIPTION OF THE DRAWINGS

FIG. 1 is a schematic diagram of a 2-phase intensive culture cycle with marine copepod Parvocalanus sp;

FIG. 2 shows comparative survival and growth rates of red snapper (Lutjanus campechanus) larvae receiving microalgae with/without addition of cultured rotifers or copepods, Parvocalanus sp;

FIG. 3a shows a 28-day-old flame angelfish (Centropyge loriculus); FIG. 3b shows a 25-day-old red snapper (Lutjanus campechanus); and FIG. 3c shows a 28 day-old bluefin trevally (Caranx melampygus);

FIG. 4 is a graph of temporal changes in the densities of Parvocalanus sp adults and copepodites under controlled growth conditions;

FIGS. 5A-C are graphs of the temporal profile of copepod density; 5A in a 30,000 L tank, Trial #1; 5B harvested from a 30,000 L tank, Trial #1; and 5C from a 30,000 L tank, Trial #2;

FIGS. 6A and 6B are bar graphs of mean percentage survival to day 7 ph for red snapper larvae receiving only microalgae, or microalgae plus rotifers or Parvocalanus sp nauplii (A) and size of red snapper larvae from the different diet groups on day 7 (B). Each value represents mean±standard deviation of 4 replicates;

FIGS. 7A-C are bar graphs of mean % feeding incidence (A), myotome height (B) and survival rate (C) for flame angelfish larvae offered Parvocalanus sp copepod nauplii at a density of 0, 1, 5, or 10 ml^{31 1}. Each value represents mean±standard deviation of 3 replicates and;

FIGS. 8A and 8B are graphs of mean standard length for flame angelfish (A) and bluefin trevally (B) reared using a combination of cultured marine copepods, rotifers and Artemia. Each value represents mean±standard deviation (variable n).

### DETAILED DESCRIPTION OF THE INVENTION

Improved methods and materials are provided for aquaculture of difficult-to-rear marine fish and other aquatic animals. Cultured copepods are employed as live feed grown concomitantly in situ on microalgae in the presence of the fish larvae or grown independently in separate tanks and fed to the fish larvae, both under selected controlled growth conditions. Particularly, Parvocalanus sp is employed as the live feed. The Parvocalanus sp can be grown on a variety of individual or mixtures of microalgae and fed to the fish larvae, where a broader spectrum of microalgae feed may be used when the copepods are grown in situ.

Parvocalanus is a large family having a large number of species. Of particular interest is a species that can be found in the coral reef areas of Kaneohe Bay, Oahu, USA. The subject Parvocalanus sp. is readily and reproducibly isolated from Kaneohe Bay and the same or equivalent species may be found in other oceanic sources. In referring to Parvocalanus sp. it is intended to include the species employed in the subject invention and other Parvocalanus sp. having the same desirable characteristics. The subject, tropicalcopepods are characterized by higher culture production densities than other tropical or temperate copepod species, with the subject species reaching production levels of 3,750 nauplii/L/day in 400-800 L batch culture systems harvested at 5 day intervals employing the conditions set forth in the Experimental section. In contrast, reported production rates for Acartia sp in 1,000 L systems is 440 nauplii/L/day and for Gladioferens imparipes in 500 L systems is 878 nauplii/L/day. Production of the subject species achieves 20 eggs/adult/day, with production of over 40 offspring/female/day or higher. In contrast, the highest production achieved with Parvocalanus crassirostris was 31 offspring/female/day. Culture densities of the subject species reach an average 20 to 45 nauplii/ml or higher. Stage-specific differences in algae needs (Chaetoceros sp. and Isochrysis sp.) are evident for optimum growth, survival, and fecundity for the subject species. In contrast, no differences were observed in fecundity of Parvocalanus crassirostris fed different algae mixtures. Mean nauplis NI stage dimensions of the subject species is 75.6 μm in length×41.3 μm in width compared to dimensions of 62.1 μm in length×38.7 μm in width for Parvocalanus crassirostris. The subject species has proven effectiveness in improving growth and survival of small, tropical marine fish species including flame angelfish (Centripyge loriculus), bluefin trevally (Caranx melampygus), and red snapper (Lutjanus campechanus).

Under favorable conditions described herein, Parvocalanus sp. nauplii metamorphose to copepodites on day 4 post-stocking, with the first adult copepods observed 18-24 hours later. The adults Parvocalanus sp. then live for up to 9 days, representing a total life span of circa. 13-14 days in culture. They can be grown with a variety of microalgae, such as Isochrysis sp, Chaetoceros sp, Tetraselmis sp, and Nannochloropsis sp, individually or together, as well as other species depending upon the conditions under which they are employed, whether grown in situ with the fish larvae or grown independently in the absence of the fish larvae. Generally, the total cell density of the microalgae will be maintained at or about in the range of about 10⁵ to 10⁷ ml⁻¹, usually in the range of about 10⁵ to 10⁶ml⁻¹. Usually, the fecundity of the Parvocalanus sp should be at least about 15 eggs/adult/day, preferably at least about 20 eggs/adult/day.

Generally, the nauplii will be presented to fish larvae in tanks or ponds of at least 200-liter capacity, but usually between 1,500 and 100,000-liter capacity, at a density of at least about 0.5 ml⁻¹, more usually at least about 5 ml⁻¹, and may be as high as 20 ml⁻¹ or higher, usually not higher, and maintained at that level during the course of larval rearing. Target densities are reached and maintained either through daily, supplemental additions of nauplii, as required, through the 2-phase copepod production system described herein, or though natural recruitment when grown in situ with the fish larvae, or a combination of both. At target levels, larvae of fish species not only ingest the nauplii, but survive beyond yolk exhaustion on the diet and grow rapidly. The Parvocalanus sp nauplii are an efficient and effective diet, particularly during the early phase of larval rearing, as compared to other common diets such as rotifers (Brachionus sp). The early phase begins at day 1 of the larvae and continues to day 5, usually day 8, and more usually day 10. In the subsequent later phase, Parvocalanus sp feeding is desirable, but less important, and may replace use of Artemia.

The rearing method employs substantially sterile conditions, using sterilized seawater or synthetic water and the larvae are reared under conditions that at least substantially inhibit the introduction of infectious agents. All of the components used in the rearing are selected or treated to be substantially free of contaminants and infectious agents.

Different protocols may be used to raise marine fish larvae using the Parvocalanus sp. Larvae are usually stocked directly or as fertilized eggs into tanks or ponds resulting in densities of usually 1 to 30 one-day-old larvae/L. Additions of Parvocalanus sp. will usually be daily, but may be made more or less frequently. Parvocalanus sp. nauplii added to the fish larvae may be advantageously raised separately in a 2-phase culture system described herein. Nauplii are first stocked in at least 600-liter vessels, usually between 1,000 and 100,000-liter vessels, and fed microalgae, individual species or combinations of species, exemplary are Isochrysis, sp. and Chaetocerous sp, and usually at at least about 150,000 cells/ml, more usually at 200,000 cells/ml or more, and may be at 10⁷, usually not more than about 10⁶, cells/ml of either or each. Other microalgae that find use include Tetraselmis sp, etc.

For the method employing separate growth of the Parvocalanus sp, namely a 2-phase system, when nauplii reach adult stage and begin to reproduce, resulting nauplii are harvested from the vessels and fed to larvae. Adults are reintroduced to the 2-phase copepod culture system to reproduce again until they reach the end of their life span.

Alternatively, the nauplii may be produced in situ, in effect 1-phase, by combining in the same environment, e.g. tank, the microalgae, the Parvocalanus sp and the fish larvae. Parvocalanus sp. grown in situ are first stocked as adults usually at least 1/ml, but no less than 0.05/ml in the presence of microalgae, desirably Isochrysis sp. or other microalgae, solely or in combination, which should be at a total concentration of between about 10⁵-10⁶, more usually 100,000-500,000, cells/ml, particularly 200,000-400 cells/ml, one day prior to stocking fish larvae, and the level maintained in that range. Adults and copepodites are maintained at targeted levels usually 1-2/ml or higher of each through natural recruitment. Supplemental additions of nauplii may be provided daily, as required, to maintain targeted naupli densities, so that a separate 2-phase copepod culture system may be necessary.

In both approaches, the environmental conditions of the larval rearing tanks are substantially the same, and target densities of copepod nauplii are between 0.5 and 10/ml, but usually 1 to 5/ml. Isochrysis sp. levels in larval rearing tanks are maintained usually between 100,000 and 500,000 cells/ml, if necessary, through daily additions from stock cultures. Salinity of the larval rearing water is usually between 15 and 35 ppt, usually about 30 to 35 ppt, with the pH at least about 7.0, and usually between 7.5 and 8.5, but no greater than 9.0. Daily water replacement will usually not exceed 20-30% daily with copepod feeding. The temperature is maintained in the range of about 20-30° C., usually between about 23° C. and 28° C., and dissolved oxygen levels usually are at least 5.0 ppm, but more usually between 5.0 and 6.5 ppm. The water conditions may be tested twice daily, but will usually be tested at least once every two days. Generally, initially fish larvae will be stocked in an amount of at least about 10 fish larvae L⁻¹, usually at least about 20 L⁻¹, more usually at least about 25 L⁻¹, and not more than about 100 L⁻¹, usually not more than about 75 L⁻¹. Under these conditions fish larvae can be raised to at least 18 days of age, desirably 25 days of age, and can go to 40 or more days of age, in relation to the particular fish species. The fish and fish larvae are then harvested from the larval rearing tanks through a center drain and into a harvest cradle with usually between 500 and 1,000 micron mesh screen, more usually about a 700 micron mesh screen

Fish that may be grown according to the subject invention include fish for human consumption, e.g. fish in the taxonomic families Lutjanidae (snappers), Etilinidae (deep water snappers), Carangidae (jacks), Serranidae (groupers, sea basses, sea perches), Mullidae (goatfishes), Polynemidae (threadfins), Rachycentridae (cobias), Coryphaenidae (dolphin fishes), Sciaenidae (drums), Scrombridae (tunas) and ornamental fish, e.g. fish in the taxonomic families Pomacanthidae (angelfishes), Chaetodontidae (butterfly fishes and related families), Acanthuridae (surgeonfishes and tangs), Pseudochromidae (basslets), Zanclidae (Morrish idol), Labridae (wrasses), Pomacentridae (damselfishes and anemonefishes), Gobioidei (gobies), Cirrhitidae (hawkfishes), Syngnathidae (pikefishes & seahorses), and families in the suborder Blennioidei (blennies).

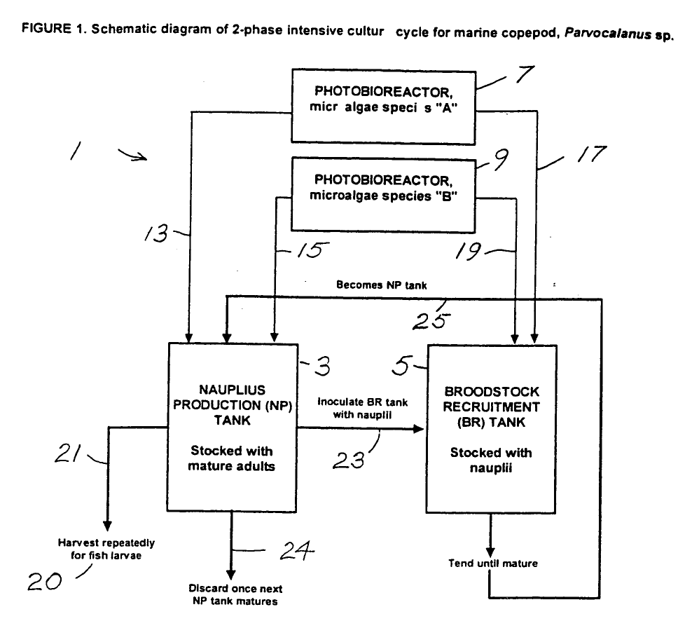

A 2-phase intensive copepod mass culture system is shown in FIG. 1. This system involves the daily harvest of Parvocalanus sp nauplii (as prey for fish larvae) and recruitment of new Parvocalanus sp adults in separate environment-controlled culture vessels 3, 5. Master cultures of adult Parvocalanus sp. are maintained separately, in usually 15-liter kreisels at usually between about 20 and 30° C., usually about 24° C. and usually between 2 and 7 adults/ml, usually 5 adults/ml, that usually contain 10-12 nauplii/ml for inoculation and restart of the 2-phase system with resulting nauplii. Copepods in the master cultures are usually fed the same algae at the same concentrations and conditions as described in the 2-phase system below.

In the 2-phase system, the copepods are fed microalgae, one or more species, e.g. 2, generated in closed photobioreactors 7, 9. The preferred conditions for the photobioreactors are: pH between 7 and 8, but no greater than 9.0; dissolved oxygen no less than 5.0, generally between 5 and 6.5 ppm; temperature between 20 and 26° C., usually about 24° C., and salinity between 15 and 35 ppt, but usually about 32 ppt. Microalgae, usually Chaetoceros sp. and Isochryis sp., and usually between 100,000 and 1,00,000 cells/ml, but at least 100,000 cells/ml, and usually between 100,000 and 300,000 cell/ml for each algae, are metered 13, 15, 17, 19 from the bioreactors into the nauplius production (NP) tank 3 and broodstock recruitment (BR) tank 5 at the appropriate concentration and species ratio for each copepod developmental stage, nauplius, copepodite, and adult. The concentrations of algae used for each developmental stage are usually the same. Concentrations of algae maintained in NP and BR tanks are between 200,000 and 400,000 cells/ml total, usually 300,000 cells/ml, and usually between 100,000 and 200,000 cells/ml of each algae, usually 150,000 cells/ml of each. The species of microalgae from bioreactor 7 or 9 used for copepod culture can be altered to match the nutritional requirements of different species of marine fish larvae.

The number of microalgae species used can also be modified with addition or deletion of other bioreactors. The amino acid, fatty acid, and proximate composition (content of lipid, protein, ash, and nitrogen-free extract) profiles of the algae used influences the profiles in copepods, their growth, survival, and fecundity. The resulting profiles in copepod nauplii, which are consumed by the fish larvae, in turn influence the profiles in fish larvae, their growth and survival. Algae are chosen with profiles that optimize copepod growth, survival, and fecundity and fish larvae growth and survival. A minimal quantity of culture water is withdrawn during nauplius harvest 21 to lessen microalgae usage. Nauplii are preferentially harvested with the use of special techniques, usually light traps that naturally separate adults and nauplii in situ. Nauplii and any non-separated copepodites and adults are then drain harvested into a 38-micron mesh sieve. This mix of copepods is then sieved through a 105-micron mesh sieve to retain adults and large copepodites, and harvest nauplii to feed fish larvae. Nauplii are usually harvested when nauplii densities reach at least 5/ml, more usually between 10 and 20/ml, or even higher. Nauplii from the production tank 3 are repeatedly harvested 21 to feed 20 fish larvae. Nauplii from the production tank 3 are initially inoculated 23 from master cultures into the BR tank 5 at densities usually between 2 and 10 nauplii/ml, more usually about 5 nauplii/ml. Once the broodstock in tank 5 matures, the remaining contents of production tank 3 are discarded 24. The mature nauplii in tank 5 are transferred 25 to production tank 3.

Preferably, the production tank 3 and the BR tank 5 are interchangeable, inoculation line 25 is reversible and the production tank 5 has a harvest line 21 and discard line 24 similar to tank 3. Instead of transferring mature nauplii from tank to tank, the functions of the tanks are interchanged. Tank 5 becomes the production tank and mature breeder nauplii are inoculated into tank 3, which becomes the BR tank.

When nauplii in tank 5 are mature, tank 3 is discharged 24. Tank 3 is filled and nauplii from tank 5 are inoculated into tank 3. Nauplii are repeatedly harvested from tank 5 and the harvest from tank 5 is transferred to feed 20 fish larvae through an outlet in tank 5 that mirrors outlet 21. When the nauplii in tank 3 are mature, the functions of the tanks are again reversed back to that shown in FIG. 1. This modular copepod production system can be scaled up in a controlled fashion by adding further NP 3 and BR 5 tanks. The 2-phase system operates in biosecure mode to avoid contamination, utilizing sterilized sea-water (15-35 ppt), usually by autoclave or ultra-violet light, or artificial sea-water made in the lab, usually in closed-loop or in a biosecure, indoor culture room, usually with positive air pressure, and with controlled personnel access, usually with disinfection prior to entry and exit.

The subject methods permit the use of electronic database control and monitoring. Samples may be automatically taken from the various tanks, analyzed as to the population and the components of the water, and the information fed into the database. By employing a computer, the data can be analyzed and the conditions associated with each tank modified as appropriate. An algorithm is employed that uses the information obtained from the samples to adjust conditions to provide for optimum copepod production and fish maturation.

The following examples are intended to illustrate but not limit the invention.

### EXPERIMENTAL

Zooplankton were collected from shallow coral reef areas in Kaneohe Bay, Oahu, Hi. using an 50 cm diameter plankton tow net of 120_m mesh aperture, towed down-current at low speed. The contents of each 5-10 min tow were concentrated into separate sealed 15 L plastic buckets and transported to an Oceanic Institute laboratory. The bucket contents were then size-fractionated using a 100_m aperture nylon screen in order to separate out adult copepods. Those organisms retained on the 100_m screen were examined using an Olympus SZX12 stereomicroscope to identify copepod species, and adult stages for culture. Twenty adult individuals of 5 different copepod species (Undinula vulgaris, Labidocera madurae, Arcatia sp, Parvocalanus sp and an unidentified cyclopoid species were then transferred by glass Pasteur pipette into separate 250 ml Erlenmeyer flasks containing filtered, UV-sterilized seawater. Four such flasks were stocked for each copepod species and each copepod species was offered the following microalgae: Chaceteros sp only, at a cell density of 1.5×10⁶ ml⁻¹; Tetraselmis sp, at a cell density of 1×10⁵ ml⁻¹; Nannochloropsis sp only, at a cell density of 6×10⁶ ml⁻¹; and the three together at cell densities of 5×10⁵ ml⁻¹, 3×10⁴ ml⁻¹, and 2×10⁶ m⁻¹respectively.

The flasks were maintained under static, continuously lit (with fluorescent lamps), conditions at 25° C. for 7 days, after which time copepod numbers, developmental stages and size distribution were quantified for each species. Parvocalanus sp exhibited the highest survival and fecundity rates of the isolated species and produced nauplii with appropriate dimensions (mean nauplius length at hatch=77.8 microns) for small marine fish larvae.

A series of experiments was carried out to compare different physical environments, microalgae concentrations and species ratios, copepod stocking densities and harvest techniques for Parvocalanus sp. Stage-dependent differences in algae requirements were found. The Parvocalanus sp fecundity equaled the best-published figures for other cultured calanoid copepod species at more than 20 eggs/adult/day. High productivity was maintained on scale-up in 15 L cultures with Parvocalanus sp nauplii densities of up to 45/ml being achieved. Copepods from these cultures were used to stock larger 600 L rearing tanks. Reliable copepod population growth was achieved. Continuous production of microalgae in closed photobioreactors was achieved for reliable high algae quantities for the system scale-up.

1 L glass beakers were used as rearing vessels in separate experiments to quantify feed uptake, survival and growth rates of flame angelfish (C. loriculus) and red snapper (L. campechanus larvae receiving different concentrations of Parvocalanus sp nauplii. The fish larvae were stocked at a density of 50 L⁻¹ into beakers containing Isochrysis sp microalgae (cell density 10⁵ml⁻¹). Parvocalanus sp nauplii were then offered to the larvae at a density of 1, 5, or 10 ml⁻¹. Larvae of both fish species ingested the nauplii and survived beyond yolk exhaustion, as well as grew rapidly.

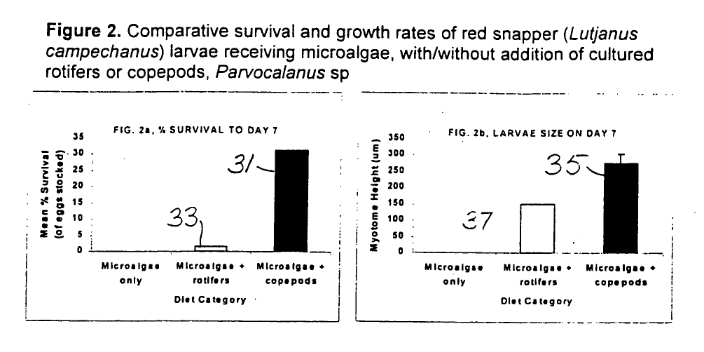

The advantage of Parvocalanus sp nauplii over other cultured live prey was shown by a comparison with rotifers (Brachionus sp) as prey for red snapper larvae. Red snapper larvae were stocked into 1 L glass beakers containing Isochrysis sp microalgae (cell density 10⁴ ml⁻¹) at a stocking density of 50 larvae L-⁻¹. Both rotifers and Parvocalanus sp nauplii were offered at a prey density of 5 organisms ml⁻¹ and the larvae's survival and growth rates and feed incidence monitored. The superior survival and growth characteristics of Parvocalanus sp-fed red snapper larvae were clear. illustrated in FIGS. 2a and 2b. As shown in FIG. 2a, Parvocalanus sp-fed larvae 31 exhibited a mean survival rate of 31.5% to day 7 post-hatch versus just 1.5% for rotifer-fed larvae 33. Also, the Parvocalanus sp-fed larvae 35 were more than 80% larger on average than rotifer-fed snapper larvae 37 by day 7 as shown in FIG. 2b. The results of these laboratory feeding experiments were verified in large-scale fish rearing trials conducted with Parvocalanus sp mass culture.

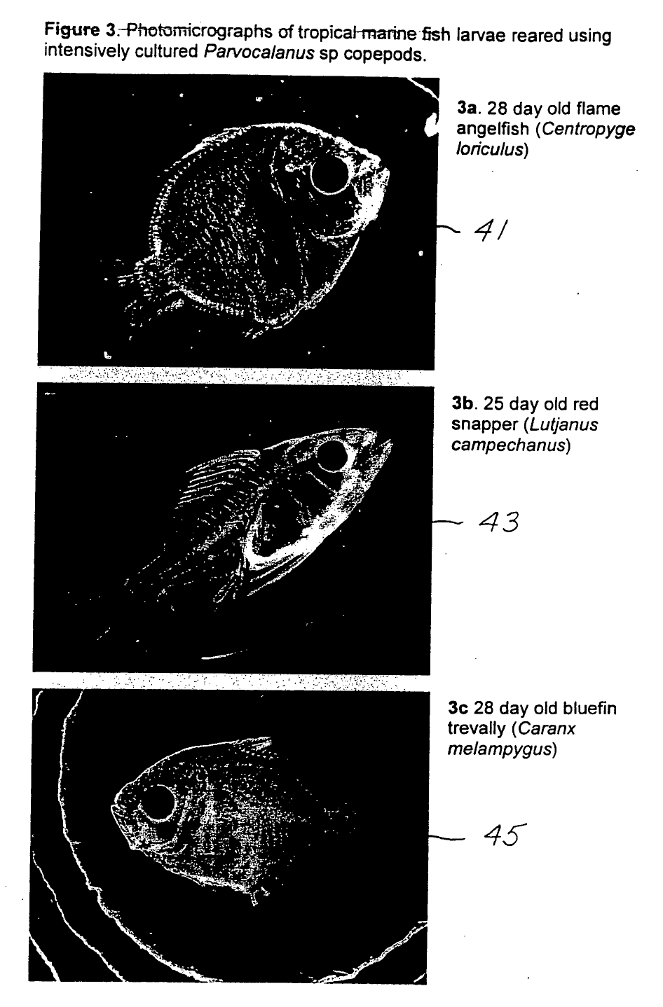

As shown in FIGS. 3a-3c, larvae of flame angelfish 41, red snapper 43 and bluefin trevally 45 were all reared to metamorphosis using intensively cultured Parvocalanus sp. Larvae of each species were stocked into 1,500 L or 4,000 L rearing tanks containing Isochrysis sp microalgae at densities ranging from 1 to 5 larvae L⁻¹. The fish larvae were fed either by controlled daily additions of the appropriate Parvocalanus sp size class or by introducing adult Parvocalanus sp, which then produced nauplii in the rearing tank.

1.1 Scale-Up of Parvocalanus sp Cultures

Work was initiated to develop intensive mass copepod culture techniques in large volume containers. This work was carried out using square polyethylene tanks 100×100×60 cm in dimension. The culture tanks were continuously lit, gently aerated and maintained at a temperature of 27-28° C.

Initial trials were carried out at 100 L or 200 L working volume, using copepods supplied from 25 L polycarbonate tanks. Culture volume was doubled each time adult copepod density reached 1 ml⁻¹, up to a maximum volume of 400 L, at which point a new culture tank was inoculated. A mixture of Chaetoceros sp and Isochrysis sp microalgae was supplied when available, although due to Isochrysis sp shortage, the cultures were sometimes fed only with Chaetoceros (cell density 300,000-500,000 ml⁻¹). Microalgae was added once per day to the desired cell density. Each culture tank was completely harvested at 3-day intervals. The harvested copepods were concentrated in a 38 μm nitex mesh bag, rinsed and re-stocked into a clean tank.

During these initial trials, Parvocalanus sp nauplius densities of up to 30 ml⁻¹ were obtained although the cultures tended to be unstable, possibly due to inconsistency of microalgae supply. Routine harvesting of nauplii was not tested during this phase.

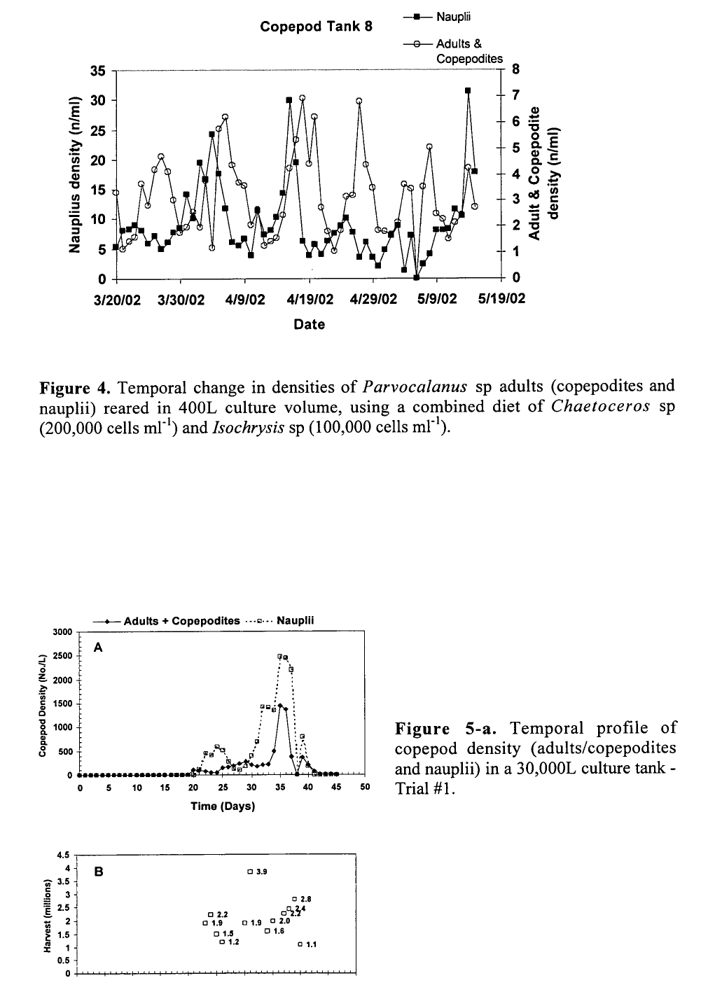

Microalgae production capacity was subsequently increased to enable routine feeding of the copepod cultures on a combination of Chaetoceros sp and Isochrysis sp. As overall copepod supply increased, the practice of splitting cultures once adult densities reached 1 ml⁻¹ was dropped without detriment to culture performance. Using this approach, individual culture tanks could be maintained indefinitely without crashing. FIG. 4 illustrates densities of Parvocalanus sp adults/copepodites and nauplii for one such tank, illustrating the characteristic cyclical fluctuations in copepod abundance.

1.2. Mass Zooplankton Culture using an Extensive, Mesocosm Approach

Preliminary trials to mass culture copepods in large outdoor tanks were conducted. Four sequential zooplankton rearing trials were conducted in 20′ diameter circular tanks with operating volume 30,000 L. The tanks were filled with seawater and inoculated with microalgae before stocking with zooplankton. Nutrients were added prior to inoculation, at 10% of the concentration normally used for microalgae mass culture, i.e.: For 30,000 L volume

Ammonium sulphate, 300 g

Monopotassium sulphate, 90 g

Urea, 15 g

Fe-EDTA, 30 g

Trace metal mix, 3 g

A water exchange rate of 10% day-1 was typically used to avoid elevation of inorganic nitrogen levels. As a general guideline, further nutrients were added when the concentration of total ammonia nitrogen fell below ˜1 mg L⁻¹.

Once a microalgae bloom had been established a mixed zooplankton population was stocked into each culture tank. The zooplankton was collected by plankton net from Kaneohe Bay and the 100-550 μm size class introduced to the culture tank. The available types and quantities of zooplankton differed on each occasion. The two predominant copepods in the 100-550 μm size class were an unidentified cyclopoid species and Parvocalanus sp. Further microalgae was added to the culture tanks as required during copepod rearing.

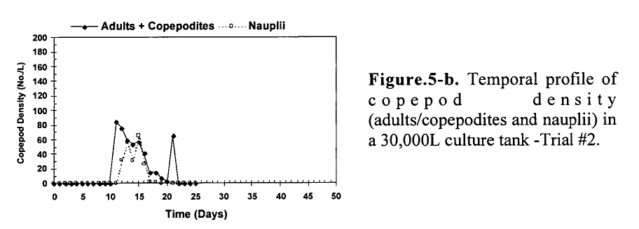

Performance was highly variable among runs. Trial #1 yielded high quantities of copepods over a three-week period, sufficient to allow repeated harvesting of nauplii as feed for fish larvae (FIGS. 5-1a&b). However, copepod productivity was much lower in trials 2-4 which were characterized by short-lived, low amplitude zooplankton blooms.

Reasons for the differences in productivity between trial #1 and trials 2-4 are unclear and are confounded by the sequential nature of the runs. It may be significant that the culture tank used for trial #1 was black in color, whereas those used for the remaining trials were white. Also, trials 2 and 4 experienced blooms of the diatom Navicula sp (unsuitable as a copepod diet) while copepod densities were still low. In contrast, the concentration of Navicula sp. in trial #1 only became elevated toward the end of the copepod production cycle.

In summary, trial #1 demonstrated the feasibility of mass culture of Hawaiian copepods using conventional extensive “mesocosm” procedures. The copepods generated in this trial were sufficient to conduct pilot scale rearing of flame angelfish and bluefin trevally larvae (see next section). While the high variability in culture performance is problematic and characteristic of such extensive zooplankton production systems, we conclude that this approach is worthy of application. In particular, the use of copepods from a defined source (i.e., indoor stock cultures), together with better control over water treatment and microalgae culture parameters, is indicative of a more reliable outdoor mass culture method.

2. Evaluation of Cultured Marine Zooplankton as Prey for Small Fish Larvae

2.1. Small Scale, “Start-Feeding” Experiments

A series of replicated experiments was carried out to quantify the feeding incidence, survival and growth rates of fish larvae offered different types and concentrations of cultured zooplankton during the critical “first-feeding” phase. These small-scale experiments were carried out in 1 L glass beakers and 25 L polycarbonate tanks, maintained without water exchange.

The following standard experimental conditions were applied. The rearing containers were placed in a temperature-controlled water bath, adjusted to 26° C. Illumination was provided by overhead fluorescent lamps, on a 12 L:12 D diurnal photoperiod. The 25 L rearing containers were gently aerated using a single, central airstone, while the 1 L containers did not receive any aeration. The rearing containers were filled with seawater from a header tank containing biofilter media. This water supply was continuously exchanged at a rate equivalent to 100% of total header tank volume per day. When required to fill the experimental rearing containers, seawater was drained from the base of the header tank via a UV-sterilizing unit.

A stocking density of 30-50 fish eggs L⁻¹ was used in all experiments. Numbers of hatched larvae and daily larvae survival rates were estimated in the 1 L glass beakers by direct visual inspection, while 50 ml water samples were taken from the 25 L containers and the contents collected on a nitex screen for counting. Larvae for size measurement and gut contents analysis were pipetted from the rearing containers, anesthetized using MS222 and examined using an Olympus SZX12 stereomicroscope. Total numbers of surviving larvae were directly enumerated at the end of each experiment.

An initial experiment was carried out with flame angelfish larvae in 25 L rearing containers, comparing the survival and growth rates of larvae receiving only Tetraselmis sp microalgae with those receiving Tetraselmis sp plus Parvocalanus sp at a density of 2 nauplii/ml (larvae experiment #3). Differences between the growth performance of the 2 diet groups were evident from an early developmental stage, such that Parvocalanus sp-fed angelfish larvae had a mean myotome height of 195.6 μm (±17.9 μm) on day 5 post-hatch, compared to a myotome height of 138.7 μm (±11.8 μm) for those receiving only Tetraselmis sp microalgae. Larvae survival rates were similar between the 2 diet groups to day ph, however those larvae offered only microalgae suffered rapid mortality during yolk exhaustion, with zero survivors remaining by day 7 ph. In contrast, Parvocalanus sp-fed flame angelfish larvae retained high rates of survival during the same critical period. Indeed, it was possible to continue rearing this group of angelfish larvae beyond the planned 7-day duration of the experiment, to 22 days ph.

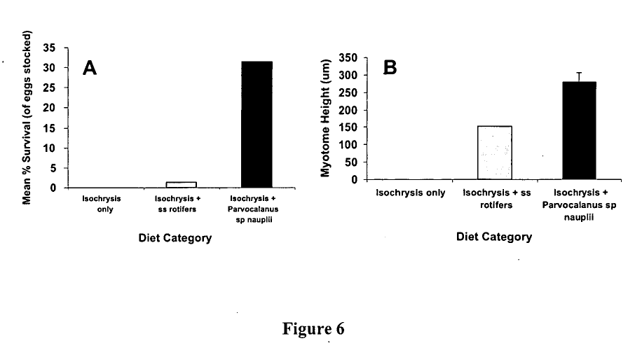

Having obtained good preliminary confirmation of Parvocalanus sp's efficacy as a larval diet, further diet research focused on culturing and evaluating this copepod species. A subsequent diet experiment with red snapper larvae in 1 L rearing containers (larvae experiment #4) compared rotifers versus Parvocalanus sp nauplii as prey. The superior survival and growth characteristics of Parvocalanus sp-fed snapper larvae are clearly illustrated in FIG. 5B Parvocalanus sp-fed larvae exhibited a mean survival rate of 31.5% to day 7 ph, versus just 1.5% for rotifer-fed larvae (FIG. 5A). Also, the Parvocalanus sp-fed larvae were more than 80% larger on average than rotifer-fed red snapper larvae by day 7 ph (FIG. 6).

In an effort to optimize prey densities for fish larvae during first-feeding, a further small scale experiment (larvae experiment #5) was carried out comparing the survival and growth rates of flame angelfish larvae offered Parvocalanus sp nauplii at densities of 0, 1, 5, or 10 nauplii ml⁻¹.

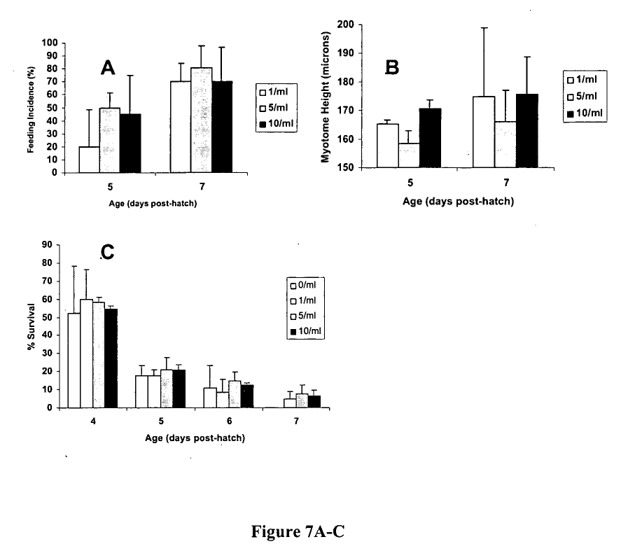

Under the conditions tested, there was no discernible advantage of offering Parvocalanus sp nauplii to flame angelfish nauplii at densities greater than 1 ml⁻¹. Larvae receiving copepod nauplii at a density of 1 ml⁻¹ exhibited lower mean feeding incidence on day 5 ph, while all three copepod-fed groups displayed similar rates of feeding incidence by day 7 (FIG. 7a). Significant differences in fish size (myotome height) were observed on day 5 ph, however these size differences were not proportional to the amount of food offered (FIG. 7b). Larvae in the 5 ml⁻¹ diet group exhibited the lowest mean myotome height on day 5. Differences in mean size were not statistically significant on day 7 post-hatch. All diet groups experienced a sharp decrease in survival between days 4 and 5 ph (FIG. 7c). No survivors were found in the microalgae-only group on day 7, while mean survival rates for the remaining copepod-fed groups ranged from 4.6% to 7.7% of hatched larvae and were not significantly different (FIG. 7c).

2.2. Pilot Scale Larvae Rearing Trials

Having established that Parvocalanus sp is an appropriate first prey organism for small tropical marine fish larvae, it was next sought to test whether cultured calanoid copepods can be used to rear larvae beyond first feeding to metamorphosis. This work was carried out in larger, 1,500 L rearing tanks equipped with water exchange. Due to the limited quantities of Parvocalanus sp available from indoor monocultures at this stage of the project, the feed required for these larger rearing tanks was harvested from an outdoor “mesocosm” system. Parvocalanus sp was the dominant, but not exclusive copepod species harvested from this system.

Three larvae rearing trials were conducted using this approach, two with flame angelfish and one with bluefin trevally. In each case, the rearing tanks were inoculated with a combination of Nannochloropsis sp and Tetraselmis sp microalgae. Copepod nauplii were added at a density of 1.5-2.0 ml⁻¹ on day 2 ph. Residual copepod levels were then monitored daily and further nauplii added as required, to maintain a density of 2 ml⁻¹ or greater. Copepod nauplii were available daily from the mesocosm system until day 10 ph, and only intermittently thereafter. Rotifers were introduced from day 11 ph and rotifer densities of 3-5 ml⁻¹ subsequently maintained by daily addition. Artemia nauplii were first offered to larvae on day 19 ph and subsequently maintained at a density of 3-5 L⁻¹.

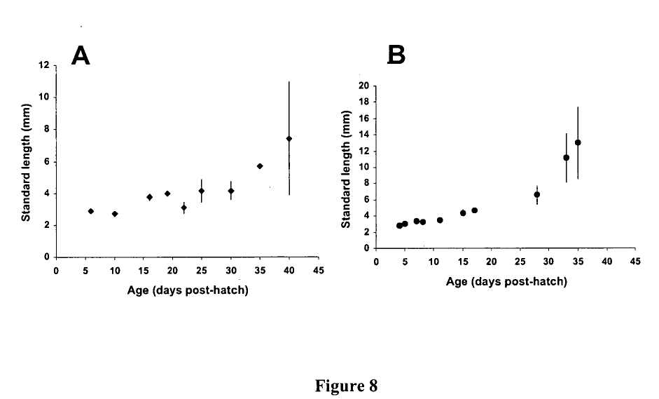

Using this approach, higher survival and growth rates of flame angelfish and bluefin trevally larvae were obtained than in any previous studies by us and a small percentage of flame angelfish survived to metamorphosis, a world first. FIG. 8 illustrates the increase in mean standard length for both fish species.

While these trials clearly demonstrated the nutritional value of cultured copepods for small tropical marine fish larvae, the onset of chronic mortality during the postlarval phase needs to be addressed, although the present showing provides a sound basis for intensive aquaculture of fish larvae. One explanation for the mortality is that the postlarvae's digestive capabilities were inadequate for processing rotifers/Artemia and that a longer period of exclusive copepod feeding would be beneficial in this respect. Alternatively, the postlarvae may have encountered adverse microbial conditions following prolonged rearing in the same tank.

The above results demonstrate the feasibility and advantages of rearing fish larvae under controlled conditions where commercial levels of production can be achieved. The processes can use a tank farm where copepods are grown under optimum conditions in a tank and then used to feed fish larvae in a rearing tank, where the process can be substantially continuous and under defined sterile conditions. Using the subject system, the growth of the fish larvae is self-contained and easily controlled. In addition, preferred feeds for the copepods and fish larvae are provided to allow for extended periods of growth, reduced mortality and high efficiencies.

All references referred to in the text are incorporated herein by reference as if fully set forth herein. The relevant portions associated with this document will be evident to those of skill in the art. Any discrepancies between this application and such reference will be resolved in favor of the view set forth in this application.

Although the invention has been described with reference to the above examples, it will be understood that modifications and variations are encompassed within the spirit and scope of the invention. Accordingly, the invention is limited only by the following claims.

What is claimed is:

1. A system for copepod culture for producing feed for larviculture comprising:
a first bioreactor containing microalgae for feeding copepods;
a nauplius production tank comprising mature copepods;
transfer means for transferring said microalgae to said nauplius production tank under predetermined conditions;
a broodstock recruitment tank;
means for harvesting nauplii from said nauplius production tank and transferring harvested nauplii to said broodstock recruitment tank;
means for transferring mature copepods from said broodstock recruitment tank to said nauplius production tank;
a fish larvae rearing tank comprising fish larvae; and
means for harvesting copepod fish larvae feed from said nauplius production tank and transferring said copepod fish larvae feed to said fish larvae rearing tank.

2. A system according to claim 1, wherein said nauplii are at least in part Parvocalanus sp.

3. A system according to claim 1 contained in a biosecure environment.

4. A system according to claim 1, wherein said microalgae comprise at least one of Isochrysis sp. and Chaetoceros sp.

5. A system according to claim 1, wherein said nauplii are a Parvocalanus sp found in Kaneohe Bay, Oahu, Hi.

6. A system according to claim 5, wherein said Parvocalanus sp are raised in vessels between about 200 and 100,000 L capacity to produce at least about 5 naupli/ml.

7. A system according to claim 5, wherein said nauplius production tank comprises microalgae at a cell density in the range of about 100,000-500,000/ml and the density of said Parvocalanus sp nauplii is in the range of about 5-20/ml.

8. A system according to claim 1, wherein said fish larvae are the larvae of red, snapper, flame angelfish or bluefin trevally.

9. A 2-phase method for rearing fish larvae comprising:
growing Parvocalanus sp under controlled and biosecure environmental conditions in vessels between 200 and 100,000 L capacity, at a temperature in the range of about 20-30° C. for production of at least about 5 nauplii/ml.

10. A method according to claim 9, wherein microalgae are fed to said Parvocalanus sp. at a cell density in the range of about 200,000-400,000/ml and the density of the Parvocalanus sp is in the range of about 5-20/ml.

11. A method according to claim 10, wherein said feeding is at a temperature in the range of about 20-30° C., salinity between 15 and 35 ppt, pH between 7.0 and 9.0, dissolved oxygen between 5.0 and 6.5 ppm, and water replacement is in the range of about 20-30% daily.

12. A method according to claim 11, wherein said fish larvae comprise fish larvae in the range of 18 to 40 days of age.

13. A 1-phase method for rearing fish larvae comprising:
combining in a single tank of at least about 200 L under a controlled and biosecure environment under the following conditions: microalgae at a cell density in the range of about 10⁵ to 10⁶/ml, Parvocalanus sp nauplii at a density of at least about 0.5/ml, fish larvae at at least about 10 L⁻¹ and at a temperature in the range of about 20-30° C.;
maintaining said conditions with water replacement in the range of about 20-30% daily; and
harvesting matured fish larvae of at least about 18 days.

14. A method according to claim 13, wherein said nauplii are a Parvocalanus sp found in Kaneohe Bay, Oahu, Hi.

15. A method according to claim 13, wherein said microalgae comprise at least one of Isochrysis sp. and Chaetoceros sp.

16. A method according to claim 13, wherein said fish larvae are the larvae of red, snapper, flame angelfish or bluefin trevally.

17. A database for encoding control of the method according to claim 1.

18. An electronic control system comprising said database according to claim 1.
